(19) United States
(12) Patent Application Publication
(10) Pub. No.: US 2010/0268778 A1
(43) Pub. Date: Oct. 21, 2010

(54) APPARATUS AND METHOD FOR SHARING IDENTITY IN UBIQUITOUS ENVIRONMENT

(75) Inventors: Soohyung Kim, Daejeon (KR); Youngseob Cho, Daejeon (KR); Sangrae Cho, Daejeon (KR); Daeseon Choi, Daejeon (KR); Jonghyouk Noh, Daejeon (KR); Seunghyun Kim, Daegu (KR); Seunghun Jin, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/747,691

(22) PCT Filed: Oct. 15, 2008
(86) PCT No.: PCT/KR2008/006084

§ 371 Date: Jun. 11, 2010

(30) Foreign Application Priority Data
Dec. 17, 2007 (KR) 1020070131956

(51) Int. Cl. G06F 17/00

(52) U.S. Cl. 709/204

(57) ABSTRACT

There is provided a method of sharing identities in a ubiquitous environment, the method including: allowing an identity sharing apparatus to receive a service message transmitted from a service provider; allowing a relationship module of the identity sharing apparatus to check whether to have a relationship with a service of the service provider that transmits the service message; displaying a portion of the received service message such that a user can select a service, when it is determined that no relationship is established; displaying relationship establishment conditions including the content of the selected service and an identity list to be provided to the service provider; allowing the service provider and the identity sharing apparatus to perform a relationship establishment protocol; and storing relationship establishment information.

### TECHNICAL FIELD

The present invention relates to an apparatus and method for sharing identities in a ubiquitous environment, and more particularly, to an identity sharing apparatus and method that enables service apparatuses surrounding users to securely share user identities in a ubiquitous environment so as to provide community or personalized services to the users having mobile ID wallets by using the relationship that is established between the mobile ID wallets of the user capable of sharing identities and ubiquitous service apparatuses within a specified space.

This work was supported by the IT R&D program of MIC/IITA [2007-S-601-01, User Control Enhanced Digital Identity Wallet System].

### BACKGROUND ART

With the advent of a ubiquitous paradigm environment that is capable of providing to service users information that the service users want to use or is most suitable for the service users anywhere and anytime using service apparatuses surrounding the users, a computing environment for supporting the ubiquitous service has been constructed.

In recent years, there have been proposed many methods of providing user information collected from sensors and apparatuses surrounding the users to service apparatuses surrounding the users and providing customized services to the users in a ubiquitous environment. However, the methods according to the related art provide information on the basis of only information obtained by sensors. Therefore, according to the methods, there are problems in that it is difficult to provide sufficient information to the users, the users have difficulty in controlling which identities are provided to the service apparatuses, or the relationship between the users and the service providers need to be continuously reestablished.

The invention has been made to meet the requirements for a method of constructing a real ubiquitous environment that enables a user to effectively control distribution of user information in a ubiquitous environment and information obtained from peripheral sensors.

### DISCLOSURE OF INVENTION

### Technical Problem

The invention is designed to solve the above problems, and an object of the invention is to provide an apparatus and method for sharing identities in a ubiquitous environment that is capable of securely sharing user identities with service providing apparatuses surrounding the users and providing personalized services to the users on the basis of the shared information in a ubiquitous environment where mutual reliability is not ensured.

Another object of the invention is to provide an apparatus and method for sharing identities in a ubiquitous environment that enables a user to use a mobile ID wallet of a user's mobile terminal to utilize various ubiquitous services, using various identities on the Internet sites and information collected by sensors of user peripheral devices.

Still another object of the invention is to provide an apparatus and method for sharing identities in a ubiquitous environment that enables a user to provide pertinent information such as a user's identity to peripheral service apparatuses through a mobile ID wallet of a user's mobile terminal under agreement, which allows the right to control the flow of the identity and the right to select a service, thereby securely protecting personal privacy.

### Technical Solution

In order to achieve the objects, according to an aspect of the invention, there is provided a method of sharing identities in a ubiquitous environment. The method includes: a service message receiving step of allowing an identity sharing apparatus to receive a service message transmitted from a service provider; a relationship establishment determining step of allowing a relationship module of the identity sharing apparatus to check whether to have a relationship with a service of the service provider that transmits the service message; a service list display step of displaying a portion of the received service message such that a user can select a service, when it is determined in the relationship establishment determining step that no relationship is established; a relationship establishment condition display step of, when the user selects a service in the service list display step, displaying relationship establishment conditions including the content of the selected service and an identity list to be provided to the service provider; a relationship establishment protocol executing step of when the user requests to establish a relationship, allowing the service provider and the identity sharing apparatus to perform a relationship establishment protocol; and a relationship establishment information storing step of, when the relationship establishment protocol executing step is completed, storing relationship establishment information.

The service message may include at least one of an identifier of the service provider, a domain of the service provider, service content, a shared identity list, and a relationship establishment service network address.

The relationship establishment protocol executing step may include a step of allowing the identity sharing apparatus to transmit a relationship establishment protocol start message including a service user identifier, using the relationship establishment service network address included in the service message.

The relationship establishment protocol executing step may include a step of allowing the identity sharing apparatus to receive, from the service provider, a response message including at least one of the position of the service provider, a service range, a service period, a privacy policy, and guarantee information, and of displaying the response message received by the identity sharing apparatus.

The relationship establishment protocol executing step may include a step of allowing the identity sharing apparatus to transmit, to the service provider, a relationship establishment completion request message including data required to generate relationship-proof information, and to receive, from the service provider, a relationship establishment completion response message including relationship establishment information.

The method may further include a step of, when it is determined in the relationship establishment determining step that the relationship is established, determining whether the service is suitable for the current context of the user.

The method may further include a step of, when it is determined in the relationship establishment determining step that the relationship is established, providing relationship verification to the service provider with reference to relationship-proof information included in the relationship establishment information.

The method may further include a step of, when it is determined in the relationship establishment determining step that the relationship is established, providing an identity to the service provider with reference to a shared identity list included in the relationship establishment information.

The identity may be provided from a secured storage unit of the identity sharing apparatus, an identity provider, or user peripheral devices to the service provider.

According to another aspect of the invention, there is provided an apparatus for sharing identities in a ubiquitous environment. The apparatus includes: a communication module that is provided for communication among a service provider, user peripheral devices, and an identity provider; a relationship module that performs a protocol for establishing a relationship with the service provider; a context module that rejects a service provided by the service provider or automatically requests a service, on the basis of at least one of environmental information, information provided by the service used, and a predetermined preference; an identity request module that requests the service provider or the user peripheral devices to transmit identity information requested by the service provider; and a secure storage unit that stores data including relationship establishment information.

The relationship module may verify relationship proof, and generates relationship-proof information.

The apparatus may further include: a dictionary module that stores different representations of the same identity for each domain such that the representations are matched with the identities; and an identity module that converts the identity requested by the service provider into a format that can be processed by the service provider with reference to the dictionary module, and provides the converted format.

The relationship establishment information may include at least one of a list of identifiers of the service providers, a domain of the service provider, guarantor information for the service provider that guarantees the service provider, and the position of the service provider.

The relationship establishment information may include a shared identity list, which is a list of identities provided from the identity sharing apparatus to the service provider.

The relationship establishment information may include relationship-proof information verifying that the identity sharing apparatus has a relationship with the service provider.

### Advantageous Effects

According to the above-described aspects of the invention, it is possible to securely share user identities with service providing apparatuses around the users and provide personalized services to the users on the basis of the shared information in a ubiquitous environment in which mutual reliability is not ensured.

It is possible to enable a user to use a mobile ID wallet of a user's mobile terminal to utilize various ubiquitous services, using a various identities on the Internet sites and information collected by sensors of user peripheral apparatuses. In addition, it is possible to enable a user to provide main information including a user's identity to peripheral service apparatuses through a mobile ID wallet of a user's mobile terminal under agreement and allows the right to control the flow of identity and the right to select a service, thereby securely protecting personal privacy.

The mobile ID wallet according to the invention is expected to serve as an integrated framework capable of integrating the existing ubiquitous service environments described by various methods into one environment.

### BRIEF DESCRIPTION OF THE DRAWINGS

FIG. 1 is a diagram illustrating the configuration of an identity.

FIG. 2 is a diagram illustrating an example of the relationship formed by an individual in a ubiquitous environment.

FIG. 3 is a diagram illustrating a personalized service environment for providing a service using identity sharing in a ubiquitous environment according to an embodiment of the invention.

FIG. 4 is a diagram illustrating relationship establishment information stored by a service provider and a service user after a relationship is established therebetween according to an embodiment of the invention.

FIG. 5 is a block diagram illustrating a mobile ID wallet according to an embodiment of the invention and peripheral devices thereof.

FIG. 6 is a flowchart illustrating a process of establishing the relationship between a service provider and a service user according to an embodiment of the invention.

FIG. 7 is a flowchart illustrating a process of providing a service from a service provider to a service user according to an embodiment of the invention.

### BEST MODE FOR CARRYING OUT THE INVENTION

Hereinafter, exemplary embodiments of the invention will be described with reference to the accompanying drawings for better understanding. The following embodiments are provided for better understanding of the invention, but the invention is not limited to the following embodiments.

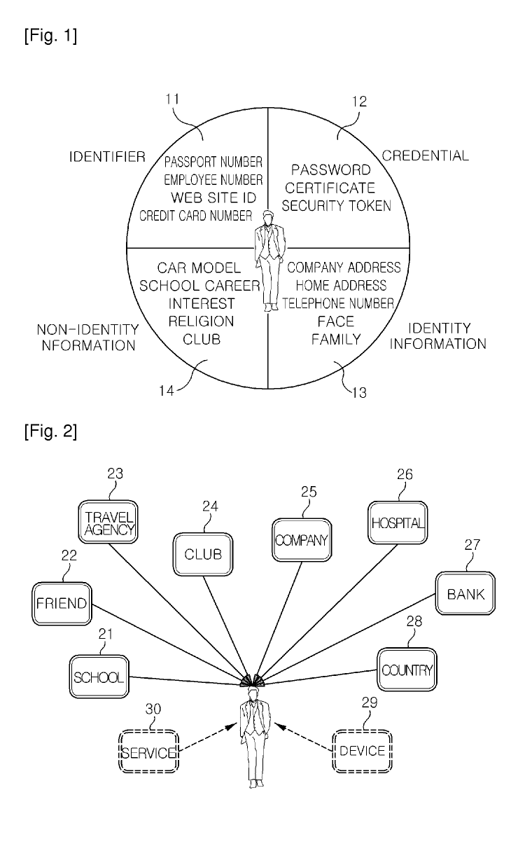

FIG. 1 is a diagram illustrating the configuration of an identity. The invention provides a technique for sharing user personal identities in a ubiquitous environment and providing services on the basis of the shared identities. Therefore, for better understanding of the invention, the meaning of the term ‘identity’ will be described first.

Individuals become members of a specific community as soon as they are born, and the social members are given their own identifiers (for example, resident registration numbers). In addition, the individual has a name as a family member, and, for example, a home address and a phone number serve as identifiers in association with the name of the individual. As the individual becomes a social member, he or she forms many relationships with other social members, and these relationships give the individual a new personal identity.

Referring to FIG. 1, a personal identity includes four components. An identifier 11 means unique information for identifying a person in a specific community, such as a passport number, an employee number, a Web site ID, and a credit card number. A credential 12 is information that is used as a means for verifying that a person is a member of a specific community in another entity, such as a password, a certificate, and a security token.

Identity information 13 and non-identity information 14 indicate personal characteristics. The identity information means user information, such as a company address, a home address, a phone number, a face, and a family, that are issued from or registered in the Government or a company, which may serve as unique information for identifying a person, similar to the identifier 11. The non-identity information 14 means information for identifying personal characteristics, such as a car model, a school career, an interest, a religion, and a club. Since the non-identity information 14 is general personal information, it is difficult to identify a user using only the non-identity information 14.

FIG. 2 is a diagram illustrating an example of the relationship between people in a ubiquitous environment. In the real community or a virtual community connected over a network, an individual forms a relationship with a subject to share information therebetween. Interaction occurs therebetween on the basis of the shared information. The interaction may occur only one time, and may be maintained permanently or for a predetermined period of time. The relationship may be established between individuals and organizations (groups) as well as between the individuals. The relationships between the individuals and the organization are formed for a special purpose. The concept of the relationships is expected to be further expanded when the ubiquitous environment is realized.

As shown in FIG. 2, in the social community, an individual forms predetermined relationships with organizations, such as a school 21, a friend 22, a travel agency 23, a club 24, a company 25, a hospital 26, a bank 27, a country 28, etc. However, in the ubiquitous environment, an individual forms relationships with the organizations through apparatuses connected to each other over the network. For example, services 30 and devices 29 surrounding users share the user identities, and can interact with the users on the basis of the shared information. That is, the services and the devices can form relationships with the users. The invention is described with the expanded relationships, and relates to a technique for establishing the relationship among an identity sharing apparatus, which is a mobile ID wallet that is used instead of a user, a service provider that shares the user identities and provides services to the users, and peripheral devices of the users.

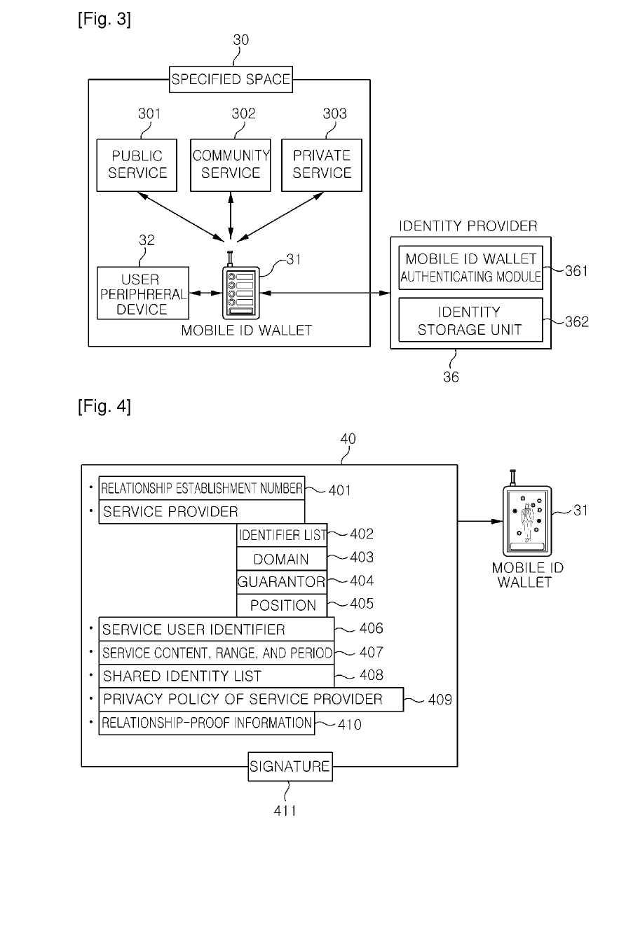

FIG. 3 is a diagram illustrating a personalized service environment for providing services using shared identities in a ubiquitous environment according to an embodiment of the invention.

In a service area defined as a specified space 30, a mobile ID wallet 31 corresponding to an identity sharing apparatus according to the invention is arranged, and a public service 301, a community service 302, a private service 303, and a user peripheral device 32 that communicate with the mobile ID wallet 31 to provide services are also arranged. Outside the specified space 30, an identity provider 36 is connected to the mobile ID wallet 31, thereby constructing a personalized service environment.

The specified space 30 is not particularly limited, but it may be a residential area of the user, a conference room, the inside of a building, or a shopping center. The specified space 30 means a peripheral area of the user where services are provided to the user.

The public service 301 means a service that can be used by the user without providing a user identity, such as positional information, advertisement, and information on interesting places. The public service 301 is commonly referred in the ubiquitous environment, but is not closely connected with the invention since it does not need to provide identities. However, it may be a basic service for creating a new service in association with the community service 302 or the private service 303. For example, when there is a service capable of notifying the position of a subject which forms a relationship with the user, it is possible to provide a service for locating the subject on the basis of the association between map information and the positional information of the subject.

The community service 302 means a service that is provided to members of a community formed in a specific area, such as a resident service, a conference register service, or an employee service. The community is an environment or a group of members that share a common interest, and the user needs to verify him or her as a member of the community on the basis of his or her own identity. The verification information is generated on the basis of the identities stored in the identity provider 36 or the mobile ID wallet 31. The user forming a relationship with a service provider for the community service 302 can be allowed to enter a specific area or receive a proper service.

The private service 303 means a customized service that is provided to persons on the basis of information on individual preference or even more various identities than that in the community service 302. A subject that provides the service should have high reliability since it handles private information. Therefore, when a person selects a provider for the customized private service 303, a guarantee of a reliable subject that has already been connected with the person is required.

The public service 301, the community service 302, and the private service 303 transmit data for the service result to the mobile ID wallet 31 of the user or a user terminal, output data transmitted from the user to a related apparatus, allow the user to use the related apparatus, or output data for the service to the related apparatus. That is, the public service 301, the community service 302, and the private service 303 can handle all of the services that are available in the ubiquitous environment.

The user peripheral devices 32 (for example, PDA and RFID reader) have a communication module, a sensing module, and an arithmetic module, and are controlled by a user. The user peripheral device 32 provided with the sensing module continuously collects user information, and provides the collected information to the mobile ID wallet 31, thereby performing the same operation as that of the identity provider 36. The user peripheral device 32 provided with the arithmetic module serves as a service provider that receives information from the mobile ID wallet 31 and provides services to the user.

The mobile ID wallet 31 performs a process required to establish the relationships with the public service 301, the community service 302, the private service 303, and the user peripheral devices 32, instead of the user, and transmits identities acquired from the identity provider 36, the user peripheral devices 32 and the users to a related subject, and allows the user to use the services provided by the related subject. The mobile ID wallet 31 is included in the identity sharing apparatus according to the invention.

The identity provider 36 stores and manages user identities, and includes a mobile ID wallet authenticating module 361 that authenticates the mobile ID wallet 31 and an identity storage unit 362 that stores user identities. The identity provider 36 transmits the user identity stored in the identity storage unit 362 to the mobile ID wallet 31 of the user after the mobile ID wallet authenticating module 361 authenticates the user. For example, when the identity provider 36 is the school from which the user graduated, the school from which the user graduated can transmit information on the entrance and graduation of the user and information on the finished courses as a graduation certificate and a transcript, respectively, at the request of the user. The identity provider 36 may establish relationships with the users to store and manage user identities. However, in the invention, there is no limitation in the relationships established between the identity provider and the users.

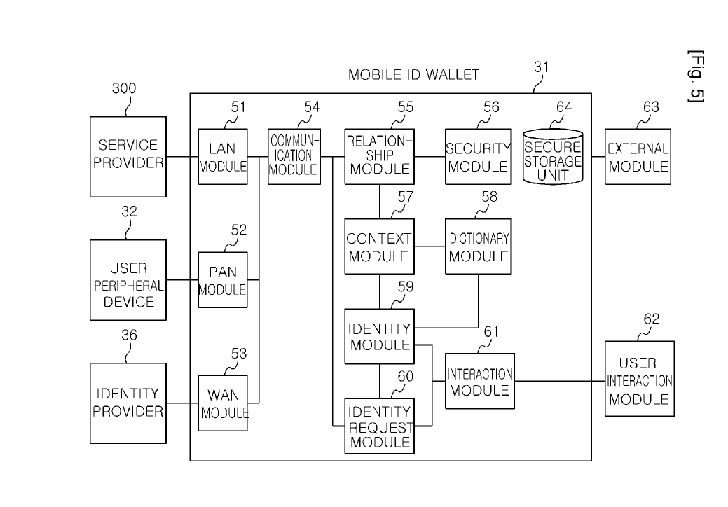

FIG. 4 is a diagram illustrating relationship establishment information stored in a service provider and a service user after the relationship is established therebetween according to an embodiment of the invention.

Relationship establishment information 40 stored in the service provider that provides ubiquitous services and the service user that uses ubiquitous services includes a relationship establishment number 401, a service provider identifier list 402, a service provider domain 403, a service provider guarantor 404, a service provider position 405, a service user identifier 406, a service content, range, and period 407, a shared identity list 408, a privacy policy of the service provider 409, relationship-proof information 410 and a signature 411.

The relationship establishment number 401 is a unique number generated by the service provider while performing a relationship establishment protocol. The service provider are, for example, the community service 302 and the private service 303 in FIG. 3, and the public service 301 and the user peripheral devices 32 may be the service provider.

The service provider identifier list 402 is a list that uniquely identifies a service provider, and may be a global identifier, such as a distinguished name (DN) of a certificate. In addition, an identifier capable of uniquely identifying a service user in a specific area may be used as the service provider identifier list. When the service provider provides the same service in a plurality of areas, the user can establish only one relationship to use the service provided in a plurality of areas. However, when the user uses the service in only the area where the relationship is established, the identifier of the service provider may be defined as an apparatus identifier of the service provider. Therefore, when the user wants to receive services in only the area when the relationship is established or a selected area, an apparatus identifier or a list of apparatus identifiers of the service provider, not a representative identifier of the service provider, is provided as the service provider identifier list 402. When the service provider wants to provide various services in association with other service providers, a list of the representative identifiers of the service providers may be provided to establish the relationships with a plurality of service providers at one time.

The service provider domain 403 may include various information items, such as a specified space where the service provider is positioned, a service range (for example, finance, travel, shopping, and entertainment), and organizations that provide services. The domain information may clarify the meaning of information used to establish the relationships. In the invention, the mobile ID wallet is not limited to a service to a specific organization, but is for ubiquitous services to be provided in various formats and ranges to various organizations. The domain information serves as important information together with a dictionary, which will be described below.

The service provider guarantor 404 guarantees the service user the reliability of the service provider, and should be a reliable third party that has already had a relationship with the service user. The guarantor generates guarantee information when the relationship is established between the service user and the service provider, and transmits the information to the service user. For example, the guarantor transmits information of the service provider and a signature value of the guarantor for the information to the service user, such that the service user can identify the guarantor. The guarantor may not be provided when the service user does not request the guarantor. However, since ubiquitous services provided in various scattered areas may cause problems, such as a phishing attack through the Internet, the guarantee of the service provider by the guarantor is useful to construct secure ubiquitous service environment.

The service provider position 405 is information describing an area where the service provider is positioned. The positional information is displayed on a screen of the mobile ID wallet 31, and can be used for the service user to check the position of the service provider having the relationship with the service user, on the basis of the current position of the service user. Since an area where many relationships have been established can be determined as the main activity area of the service user, information obtained by analyzing the positional information may be used as an identity. If the service provider has mobility, the positional information may be alternative information that is used as an input value of a service for finding the current position of the service provider.

The service user identifier 406 is information for allowing the service provider to uniquely identify a service user, and may be a global identifier, such as DN of a certificate, or an identifier unique to a corresponding service. That is, the relationship may be established such that the anonymity of a service user is ensured.

The service content, range, and period 407 is information designating the content and range of the service provided by the service provider and the available period of the established relationship. The service range may depend on the degree of the identity provided to the service.

The shared identity list 408 indicates a list of identities provided from the service users to the service provider. The privacy policy 409 of the service provider defines how the service provider uses the identities provided from the service users. The relationship-proof information 410 is used to verify that the relationship has already been established between the service provider and the service user. For example, the relationship-proof information 410 may be a shared secret value, or a value that is generated by performing extraction, change, or substitution on some or all the data stored after the relationship establishment. The signature 411 is information that can be used to verify the validity of relationship establishment data transmitted from the service provider to the service user at the time when a relationship establishment protocol is completed, or for other purposes.

FIG. 5 is a block diagram illustrating the mobile ID wallet 31 according to an embodiment of the invention and peripheral devices thereof. The mobile ID wallet 31 is a component of a mobile terminal, and is operated in association with an external module 63 and a user interaction module 62 of the mobile terminal. The mobile ID wallet 31 may be connected to the service provider 300, the user peripheral devices 32 and the identity provider 36.

The mobile ID wallet 31 includes a LAN module 51, a PAN module 52, a WAN module 53, a communication module 54, a relationship module 55, a security module 56, a context module 57, a dictionary module 58, an identity module 59, an identity request module 60, an interaction module 61 and a secure storage unit 64.

The LAN (local area network) module 51 is provided for communication between an apparatus of the service provider 300 and the mobile ID wallet 31 in the specified space 30 shown in FIG. 3. The PAN (personal area network) module 52 is provided for communication between the user peripheral devices 32 and the mobile ID wallet 31. The WAN (wide area network) module 53 is provided for communication between an apparatus of the identity provider 36 and the mobile ID wallet 31. In FIG. 5, the LAN module 51, the PAN module 52, and the WAN module 53 are separately provided and connected to the corresponding apparatuses. However, they may be connected to one or more apparatuses by one or more network connection methods.

The communication module 54 extracts data from communication messages received from the LAN module 51, the PAN module 52, or the WAN module 53, and transmits the extracted data to the relationship module 55. In addition, the communication module 54 converts data requested by the relationship module into a communication message, and transmits the communication message to the LAN module 51, the PAN module 52, or the WAN module 53.

The relationship module 55 performs a protocol to establish the relationship between the service provider 300 and the mobile ID wallet 31. The relationship module 55 verifies the relationship between the service provider and the service user before processing the identity request from the service provider 300, or generates relationship-proof information to be provided to the service provider and the service user.

The security module 56 has a function of providing an encoding library that is required for the verification of signature information and relationship proof, and the generation of relationship proof, and a function of stably transmitting and managing identifies or data for relationship-proof information.

The context module 57 rejects services provided from a specific service provider 300 or automatically requests a specific service provider 300 to provide services, on the basis of environmental information collected from the user peripheral devices 32, information provided from the service that is currently used by the user, and user's preference that has been previously set. The context module 57 can recognize various conditions using various methods, such as integration, induction, or detection, and learning, on the basis of the provided information, but a detailed description of the recognition of the conditions will be omitted in the invention. The invention differs from the existing research in that basic information required to recognize the conditions is acquired from reliable apparatus, service, and user.

The dictionary module 58 allows the mobile ID wallet 31 to recognize differently represented identities of the service providers 300. The dictionary module 58 stores different representations of the same identity for each domain such that the representations are matched with the identities. For example, when a service provider a of domain A represents an identity indicating a name as ‘Name’ and a service provider b of domain B represents it as ‘Fullname’, the mobile ID wallet 31 can recognize that two representations are identifiers indicating a name. Therefore, the dictionary module manages a dictionary of domain A using the same representation as that of the service provider a and a dictionary of domain B using the same representation as that of the service provider b to enable the mobile ID wallet to recognize that a ‘name’ identity is requested using the dictionary of the domain A when the service provider a requests the name and the dictionary of the domain B when the service provider b requests the name. The user may download the dictionaries of the domain in order to install the dictionaries when the user belongs to the domain, or dictionaries of the main domains have already been installed. Alternatively, the user may use the dictionaries stored in a dictionary server connected to a network.

The identity module 59 converts an identity requested by the service provider 300 into a format that can be processed by the service provider with reference to the dictionary module 58, on the basis of the user identities managed by the mobile ID wallet 31, the identities collected from the user peripheral devices 32, or the identities provided by the identity provider 36, and provides the changed identity to the service provider.

The identity request module 60 requests the identity provider 36 or the user peripheral devices 32 to transmit identity information of an item requested by the service provider 300, and receives the requested information. A step of requesting the identity may include a user authentication step or a step of encoding a request message or signing a request message. When the user peripheral device 32 or the identity provider 36 forms a relationship with the mobile ID wallet 31 using a relationship establishment protocol, relationship-proof information may be used to perform the user authenticate step.

The interaction module 61 transmits/receives information on a user identity, user preference, and user identification to/from the external module 63 and the user interaction module 62 that is provided in a mobile terminal having the mobile ID wallet 31 therein or is directly provided in the mobile ID wallet 31. The user interaction module 62 provides, to the user, necessary information for the user through interfaces (for example, an LCD, a speaker, and a vibrator) or receives necessary information from the user.

The external module 63 processes identity data or service result data provided by the service provider 300 that cannot be processed by the mobile ID wallet 31, and transmits the result to the mobile ID wallet 31 or the user.

The secure storage unit 64 stably stores and manages relationship establishment information, identity data, or security (for example, encryption and signature) data, and prevents the mobile terminal having the mobile ID wallet 31 provided therein from extracting data stored in the secure storage unit 64. The secure storage unit 64 may be implemented by a hardware (a USIM module in a mobile phone) or software (lock by encryption) component.

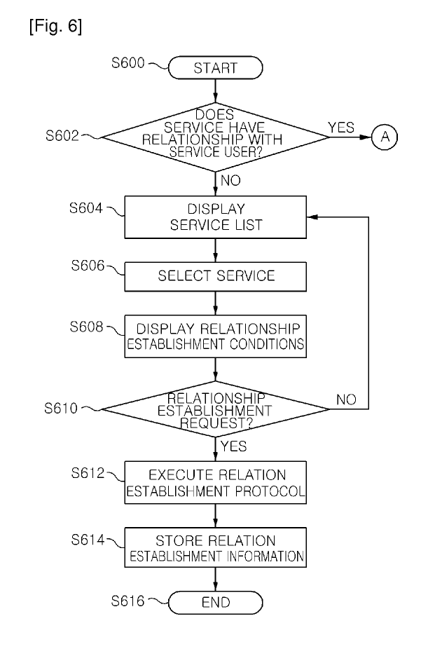

FIG. 6 is a flowchart illustrating a process of establishing the relationship between a service provider and a service user according to an embodiment of the invention. In this embodiment, for example, the service user is a mobile ID wallet or a mobile terminal having the mobile ID wallet provided therein. The relationship establishing process will be described with reference to FIG. 6 along with FIGS. 4 and 5.

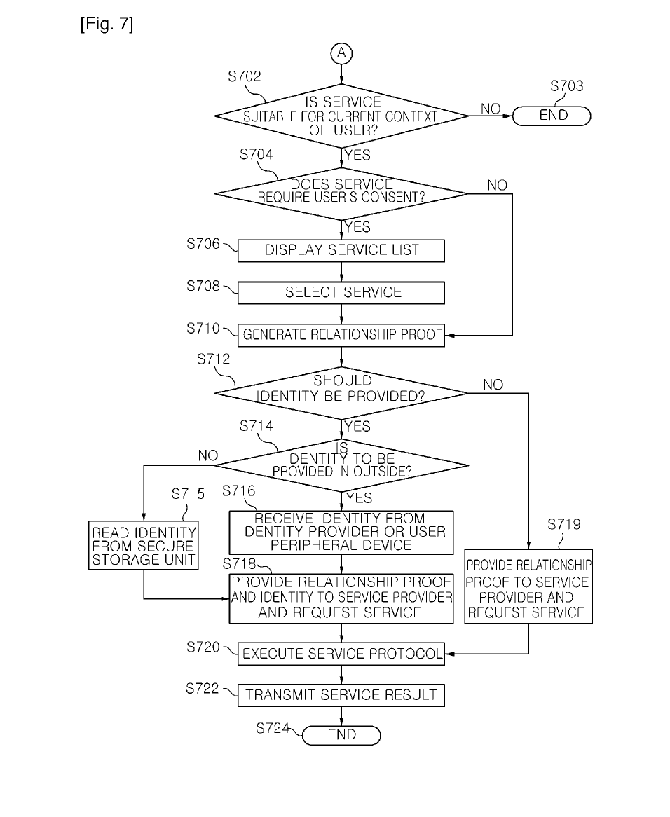

When the service provider transmits its services in a specified space and the mobile ID wallet receives the transmitted information, the process starts (S600). The service provider transmits in a specified space a service message including the service provider identifier 402, the service provider domain 403, and the service content 407. The service message also includes the shared identity list 408 that is provided by the service user for using the service, and a relationship establishment service network address. When the LAN module 51 of the mobile ID wallet receives the transmitted service message and the communication module 54 extracts data from the received service message, the relationship module 55 determines whether the relationship with the received service provider identifier 402 has been established (Step S602). If it is determined that the relationship is established, the process shown in FIG. 7 is performed. On the other hand, if it is determined that the relationship is not established, the process proceeds to the next Step S604. Alternatively, in order to start the service in Step S600, the service provider may transmit only the service provider identifier 402 through a device, such as an RFID tag, in a specified space. In this case, the mobile ID wallet uses the received service provider identifier to perform a service discovery, thereby checking the content of the service.

In Step S604, a portion of the information of the service provided by the service provider that has no relationship with the mobile ID wallet is displayed to the user. The dictionary module 58 uses the dictionary of the received domain to convert an identity list into an identifier that can be recognized by the mobile ID wallet. The interaction module 61 converts service content and a mobile ID wallet identifier into values that can be recognized by the user (for example, an identifier ‘http://etri.re.kr/id/name’ may be converted into a ‘user name’), and transmits the converted values to the user interaction module 62. Then, the user interaction module 62 briefly displays a service list and service content.

In Step S606, the user selects a desired service from the displayed services. When the user selects no service, it is determined that there is no service that the user wants to use, and the process ends. When the user selects a service, relationship establishment conditions including details of the selected service are displayed in Step S608. The content of the selected service and an identity list required to use the selected service are displayed.

In Step S610, the user determines whether to provide a corresponding identity to the service provider in order to use the service, on the basis of the displayed information. In Step S610, the user is given the right to use the identity and the right to control the identity. When the user requests relationship establishment, the user interaction module 62 transmits a signal instructing to start a relationship establishment protocol to the relationship module 55 through the interaction module 61. When the user does not request relationship establishment, the process returns to Step S604 to display the service list again such that the user can select a service.

In Step S612, the service provider and the service user perform the relationship establishment protocol. The service user uses the relationship establishment service network address provided by the service provider to transmit a relationship establishment protocol start message including the service user identifier 406 and the identity 408 required to establish the relationship. The service provider may restrict the use of the services by the service user using the identity required in the relationship establishing process. The service provider processes the protocol start message to check whether the received service user identifier 406 has already been registered or whether the received identity satisfies conditions for using the service.

Then, the service provider transmits, to the mobile ID wallet (service user), the position 405 of the service provider, the service range and period 407, the privacy policy 409 of the service provider, and a response message including guarantee information received from the guarantor 404, which is an optional item. The mobile ID wallet displays the received information to the user to request an agreement with the establishment of the relationship.

When the user agrees with the establishment of the relationship, the service provider generates data required to generate the relationship-proof information 410, and transmits a relationship establishment completion request message including the data to the service provider. The service provider finally generates data required to generate relationship-proof information, on the basis of the data required to generate relationship-proof information, which is transmitted from the mobile ID wallet, and transmits, to the mobile ID wallet, a relationship establishment completion response message including data for the items of the relationship establishment information 40 shown in FIG. 4 and the signature 411. The data required to generate relationship-proof information may use a key exchange protocol based on a public key. Alternatively, the data may use other protocols or mechanisms.

In Step S614, after the relationship establishment protocol is completed, the mobile ID wallet verifies data signed in the relationship establishment completion response message, extracts the data, and stores data including relationship establishment information in the secure storage unit 64. Similarly, the service provider stores the data in its own storage unit and shares the data.

Finally, in Step S616, if necessary, the relationship establishment completion information is displayed to the user, or the user uses the service provided by the service provider that has a relationship with the service user. Then, the relationship establishing process ends.

FIG. 7 is a flowchart illustrating a process of providing services from a service provider to a service user according to an embodiment of the invention. The service providing process will be described with reference to FIG. 7 along with FIGS. 4 and 5. In Step S602 shown in FIG. 6, when it is determined that a service is provided by the service provider that has had a relationship with the service user, the process proceeds to Step S702 in FIG. 7.

In Step S702, it is determined that the service provided by the service provider is suitable for the current context of the user. The context module 57 of the mobile ID wallet determines whether to use the service provided by the service provider, on the basis of environmental information collected from the user peripheral devices 32, information provided by the service that is currently used by the user, and user's preference that is set beforehand. If it is determined that the service is available, the process proceeds to Step S704. On the other hand, if it is determined that the service is not suitable for the current context of the user, the process proceeds to Step S703 and then ends.

In Step S704, it is determined whether the service provided by the service provider requires the user's consent. The determination is performed according to the preselection of the user or the content of the service. If it is determined that the service requires the user's consent, the process proceeds to Step S706. If it is determined that the service does not require the user's consent, the process proceeds to Step S710.

In Step S706, the user interaction module 62 displays a list of the services required for the user's consent. In Step S708, the user selects a desired service from the display service list.

In Step S710, relationship-proof information to be transmitted to the service provider providing the selected service is generated. Relationship-proof information that is stored when the relationship with the service provider for the selected service is established is read from the secure storage unit 64. Then, either the relationship-proof information is used without any changes, or it is subjected to extraction, change, and substitution to generate a relationship-proof value.

In Step S712, it is determined whether to provide an identity to the service provider. The shared identity list 408 that is stored when the relationship with the service provider for the selected service is established is read from the secure storage unit 64, and it is checked whether there is an identity to be provided for the service in the list. If it is determined that there is an identity to be provided in the list, the process proceeds to Step S714. On the other hand, if it is determined that there is no identity to be provided, the process proceeds to Step S719 to generate a service request message including relationship-proof information and transmit the generated message to the service provider.

In Step S714, it is determined whether an identity to be provided is in the outside. If it is determined that the identity to be provided is in the inside (NO in Step S714), that is, if it is determined that the identity to be provided is in the secure storage unit 64, the process proceeds to Step S715 to read the identity from the secure storage unit 64. On the other hand, if it is determined that the identity to be provided is in the outside (Step YES in S714), that is, if it is determined that the identity to be provided is not in the secure storage unit 65, the process proceeds to Step S716 to receive the identity from the identity provider 36 or the user peripheral device 32. In Step S718, a service request message including relationship-proof information and an identity is generated and then transmitted to the service provider.

The service provider having received the relationship-proof information and the identity from the service user in Step S718 or Step S719 executes a service protocol in Step S720. The service provider checks the relationship-proof information received from the service user, and uses the received identity to execute the service protocol. The service provider received the service request message extracts relationship-proof information and identity information from the service request message, and verifies the relationship proof. When the relation proof is verified, the service provider executes the service protocol using its own data and devices and related devices. The service protocol depends on the kind of service.

In Step S722, the service result, which is the result of the service protocol executed in Step S720, is transmitted to the devices of the service provider or related devices, or the mobile ID wallet, which is a service user, according to the kind of services provided by the service provider. The invention relates to most of the services provided in the ubiquitous environment. Therefore, a destination of the service result is not particularly limited.

In Step S724, the transmitted service result is displayed to the user, stored, or printed out. Thereafter, the service ends. When the service result is transmitted to the apparatus of the service provider, the apparatus can display the result, use the result to provide a new service, or allow access to an access restricted area on the basis of the result. When the service result is transmitted to the mobile ID wallet, the mobile ID wallet can store the result in the secure storage unit or display it to the user. In addition, the mobile ID wallet can transmit the result to the user peripheral device 32 such that the user peripheral device can process the result, or transmit the result to the external module 63 such that the external module can process the result.

### INDUSTRIAL APPLICABILITY

The apparatus and method for sharing identities in a ubiquitous environment according to the invention is expected to serve as an integrated framework that integrates the existing ubiquitous service environments described by various methods into one environment.

1. A method of sharing identities in a ubiquitous environment, the method comprising:
a service message receiving step of allowing an identity sharing apparatus to receive a service message transmitted from a service provider;
a relationship establishment determining step of allowing a relationship module of the identity sharing apparatus to check whether to have a relationship with a service of the service provider that transmits the service message;
a service list display step of displaying a portion of the received service message such that a user can select a service, when it is determined in the relationship establishment determining step that no relationship is established;
a relationship establishment condition display step of, when the user selects a service in the service list display step, displaying relationship establishment conditions including the content of the selected service and an identity list to be provided to the service provider;
a relationship establishment protocol executing step of, when the user requests to establish a relationship, allowing the service provider and the identity sharing apparatus to executes a relationship establishment protocol; and
a relationship establishment information storing step of, when the relationship establishment protocol executing step is completed, storing relationship establishment information.

2. The method of claim 1,
wherein the service message includes at least one of an identifier of the service provider, a domain of the service provider, service content, a shared identity list, and a relationship establishment service network address.

3. The method of claim 1,
wherein the relationship establishment protocol executing step includes:
a step of allowing the identity sharing apparatus to transmit a relationship establishment protocol start message including a service user identifier, using the relationship establishment service network address included in the service message.

4. The method of claim 1,
wherein the relationship establishment protocol executing step includes:
a step of allowing the identity sharing apparatus to receive, from the service provider, a response message including at least one of a position of the service provider, a service range, a service period, a privacy policy, and guarantee information, and of displaying the response message received by the identity sharing apparatus.

5. The method of claim 1,
wherein the relationship establishment protocol executing step includes:
a step of allowing the identity sharing apparatus to transmit, to the service provider, a relationship establishment completion request message including data required to generate relationship-proof information, and to receive, from the service provider, a relationship establishment completion response message including relationship establishment information.

6. The method of claim 1, further comprising:
a step of, when it is determined in the relationship establishment determining step that the relationship is established, determining whether the service is suitable for the current context of the user.

7. The method of claim 1, further comprising:
a step of, when it is determined in the relationship establishment determining step that the relationship is established, providing relationship proof to the service provider with reference to relationship-proof information included in the relationship establishment information.

8. The method of claim 1, further comprising:
a step of, when it is determined in the relationship establishment determining step that the relationship is established, providing an identity to the service provider with reference to a shared identity list included in the relationship establishment information.

9. The method of claim 8,
wherein the identity is provided from a secure storage unit of the identity sharing apparatus, an identity provider, or user peripheral devices to the service provider.

10. An apparatus for sharing identities in a ubiquitous environment, the apparatus comprising:
a communication module that is provided for communication among a service provider, user peripheral devices, and an identity provider;
a relationship module that performs a protocol for establishing a relationship with the service provider;
a context module that rejects a service provided by the service provider or automatically requests a service, on the basis of at least one of environmental information, information provided by the service used, and a predetermined preference;
an identity request module that requests the identity provider or the user peripheral devices to transmit identity information requested by the service provider; and
a secure storage unit that stores data including relationship establishment information.

11. The apparatus of claim 10,
wherein the relationship module verifies relationship proof, and generates relationship-proof information.

12. The apparatus of claim 10, further comprising:
a dictionary module that stores different representations of the same identity for each domain such that the representations are matched with the identities; and
an identity module that converts the identity requested by the service provider into a format that can be processed by the service provider with reference to the dictionary module, and provides the converted format.

13. The apparatus of claim 10,
wherein the relationship establishment information includes at least one of a list of the identifiers of the service providers, a domain of the service provider, guarantor information for the service provider that guarantees the service provider, and the position of the service provider.

14. The apparatus of claim 10,
wherein the relationship establishment information includes a shared identity list, which is a list of identities provided from the identity sharing apparatus to the service provider.

15. The apparatus of claim 10,
wherein the relationship establishment information includes relationship-proof information verifying that the identity sharing apparatus has a relationship with the service provider.
